(19) United States
(12) Patent Application Publication
(10) Pub. No.: US 2026/0356450 A1
(43) Pub. Date: Nov. 12, 2026

(54) BICYCLE SADDLE

(71) Applicant: TREK BICYCLE CORPORATION, WATERLOO, WI (US)

(72) Inventor: Kayla O'Neill, WATERLOO, WI (US)

(21) Appl. No.: 19/205,000

(22) Filed: May 12, 2025

(51) Int. Cl. B62J 1/18; B62J 1/00

(52) U.S. Cl. CPC B62J 1/18; B62J 1/002

(57) ABSTRACT

A bicycle saddle includes a saddle base and a saddle cushion that mounts to the saddle base. The saddle cushion comprises a plurality of unit cells, where each unit cell in the plurality of unit cells comprises a truncated octahedron. Each unit cell in the plurality of unit cells is formed from a plurality of unit cell struts that interconnect to form a lattice of unit cells.

### BACKGROUND

A bicycle saddle, or seat, is a contact point of a bicycle that is used to support a portion of the cyclist's weight. A primary design consideration for a bicycle saddle is the amount of comfort it provides to the cyclist. Other saddle design considerations include the overall weight of the saddle, the aesthetic appearance of the saddle, the ease of manufacturing the saddle, the amount of difficulty involved in making saddle adjustments by the cyclist, etc.

### SUMMARY

An illustrative bicycle saddle includes a saddle base and a saddle cushion that mounts to the saddle base. The saddle cushion comprises a plurality of unit cells, where each unit cell in the plurality of unit cells comprises a truncated octahedron. Each unit cell in the plurality of unit cells is formed from a plurality of unit cell struts that interconnect to form a lattice of unit cells.

In an illustrative embodiment, each unit cell in the plurality of unit cells has a height, a width, and a depth, and wherein the height is greater than the width. In one embodiment, a ratio of the height to the width of each unit cell is 4/3:1. In another embodiment, the height is greater than the depth, and a ratio of the height to the depth of each unit cell is 4/3:1. In another embodiment, the plurality of unit cells are oriented such that the height of each unit cell is perpendicular to a ground surface.

In an illustrative embodiment, the plurality of unit cell struts vary in diameter across the saddle cushion. In one embodiment, the saddle cushion includes a first zone that is positioned to receive sits bones of a user and a second zone that is positioned to not receive the sits bones of the user. The unit cell struts used in the first zone have a first diameter and unit cell struts used in the second zone have a second diameter that differs from the first diameter. In one embodiment, the first diameter is greater than the second diameter, and in another embodiment the first diameter comprises 1.1 millimeters and the second diameter comprises 1 millimeter. In another embodiment, the saddle cushion also includes a transition zone that is in between the first zone and the second zone. At least a portion of the unit cell struts used in the transition zone have a third diameter that differs from the first diameter and the second diameter. In an illustrative embodiment, the third diameter is smaller than the first diameter and larger than the second diameter.

In another illustrative embodiment, the truncated octahedron that forms each cell includes a first set of hexagonal faces having first dimensions and a second set of hexagonal faces having second dimensions, where the first dimensions differ from the second dimensions. In another embodiment, a ratio of a height to a depth of each unit cell is up to 2.5:1.

An illustrative saddle cushion for a bicycle saddle comprises a plurality of unit cells, wherein each unit cell in the plurality of unit cells comprises a truncated octahedron. Each unit cell in the plurality of unit cells is formed from a plurality of unit cell struts that interconnect to form a lattice of unit cells. In one embodiment, each unit cell in the plurality of unit cells has a height, a width, and a depth, where the height is greater than the width and the depth. In another embodiment, a ratio of the height to the depth of each unit cell is 4/3:1. In another embodiment, the plurality of unit cells are oriented such that the height of each unit cell is perpendicular to a ground surface.

In another embodiment, the saddle cushion includes a first zone that is positioned to receive sits bones of a user and a second zone that is positioned to not receive the sits bones of the user. Unit cell struts used in the first zone have a first diameter and unit cell struts used in the second zone have a second diameter that is smaller than the first diameter. In an illustrative embodiment, the truncated octahedron that forms each cell includes a first set of hexagonal faces having first dimensions and a second set of hexagonal faces having second dimensions, and the first dimensions differ from the second dimensions.

Other principal features and advantages of the invention will become apparent to those skilled in the art upon review of the following drawings, the detailed description, and the appended claims.

### BRIEF DESCRIPTION OF THE DRAWINGS

Illustrative embodiments will hereafter be described with reference to the accompanying drawings, wherein like numerals denote like elements. The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 depicts a bicycle with a saddle composed of truncated octahedron cells in accordance with an illustrative embodiment.

FIG. 2A depicts a full octahedron in accordance with an illustrative embodiment.

FIG. 2B depicts pyramids at the corners of the octahedron that are removed to form the truncated octahedron shape in accordance with an illustrative embodiment.

FIG. 2C depicts the truncated octahedron solid that results from removal of the pyramids shown in FIG. 2B in accordance with an illustrative embodiment.

FIG. 3A is a bottom perspective view of a bicycle saddle that includes a saddle cushion mounted to a saddle base (or shell) in accordance with an illustrative embodiment.

FIG. 3B is a top perspective view of the bicycle saddle of FIG. 3A in accordance with an illustrative embodiment.

FIG. 3C is a top view of a 3D printed foam replacement saddle cushion in accordance with an illustrative embodiment.

FIG. 3D is a side view of the 3D printed foam replacement saddle cushion in accordance with an illustrative embodiment.

FIG. 4 depicts a truncated octahedron with attached struts (i.e., from other truncated octahedrons) such that a truncated octahedron lattice can be formed in accordance with an illustrative embodiment.

FIG. 5A depicts the two rectangular faces of the truncated octahedron in accordance with an illustrative embodiment.

FIG. 5B is a bottom view of the truncated octahedron with labels showing like dimensions of the structure in accordance with an illustrative embodiment.

FIG. 5C is a view showing ‘a’ hexagonal faces in accordance with an illustrative embodiment.

FIG. 5D is a view showing ‘b’ hexagonal faces in accordance with an illustrative embodiment.

FIG. 5E is a view showing two of the four diamond faces of the truncated octahedron in accordance with an illustrative embodiment.

FIG. 6 depicts various views of a 4 cm×4 cm×4 cm truncated octahedron lattice structure containing truncated octahedron unit cells of size 1 cm×1 cm×1 cm in accordance with an illustrative embodiment.

FIG. 7 depicts the height, width, and depth dimensions of a truncated octahedron cell with attached struts (i.e., from other truncated octahedrons) in accordance with an illustrative embodiment.

FIG. 8 depicts an elongated truncated octahedron cell with attached struts (i.e., from other truncated octahedrons) in which the ratio of the height of the cell to the width of the cell is 4/3:1 in accordance with an illustrative embodiment.

FIG. 9 is a graph showing the results of testing load testing (Newtons) to determine the displacement (mm) of truncated octahedron lattices having various sizes in accordance with an illustrative embodiment.

FIG. 10 depicts a simulation of a 6×6×8 (4/3:1) truncated octahedron cell under shear force in accordance with an illustrative embodiment.

FIG. 11A depicts strut diameter zones of a saddle cushion in accordance with an illustrative embodiment.

FIG. 11B is a chart that shows strut diameter in a 20 mm transition zone positioned between a first zone with 1.1 mm struts and a second zone with 1 mm struts in accordance with an illustrative embodiment.

FIG. 11C depicts a portion of the overlap shape that defines the first saddle zone and shows that the direction the struts ramp is perpendicular to tangent edges of the first zone in accordance with an illustrative embodiment.

FIG. 12 depicts a portion of a saddle cushion in which the truncated octahedron cells of the lattice are oriented such that cell height is perpendicular to the ground surface upon which the bicycle rests in accordance with an illustrative embodiment.

FIG. 13 is a graph that shows the results of dynamometer testing done in a suspension lab in accordance with an illustrative embodiment.

FIG. 14 is a table that depicts results of the load testing of lattice cubes having various cell shapes/types in accordance with an illustrative embodiment.

### DETAILED DESCRIPTION

Described herein is a bicycle saddle that includes a saddle base, a saddle cushion mounted to a top side of the saddle base, and saddle rails mounted to a bottom side of the saddle base. The saddle rails mount to a seatpost to secure the bicycle saddle to the bicycle frame. In an illustrative embodiment, the saddle cushion can be composed of a plurality of interconnected truncated octahedron cells. As discussed in more detail below, a truncated octahedron is an Archimedean solid that results from the removal of six pyramids from a regular octahedron, one at each vertex of the regular octahedron. In another illustrative embodiment, the saddle can be formed by additive manufacturing (i.e., three-dimensional (3D) printing), as discussed in more detail below. Alternatively, any other manufacturing technique can be used, such as molding, thermoforming, machining, etc.

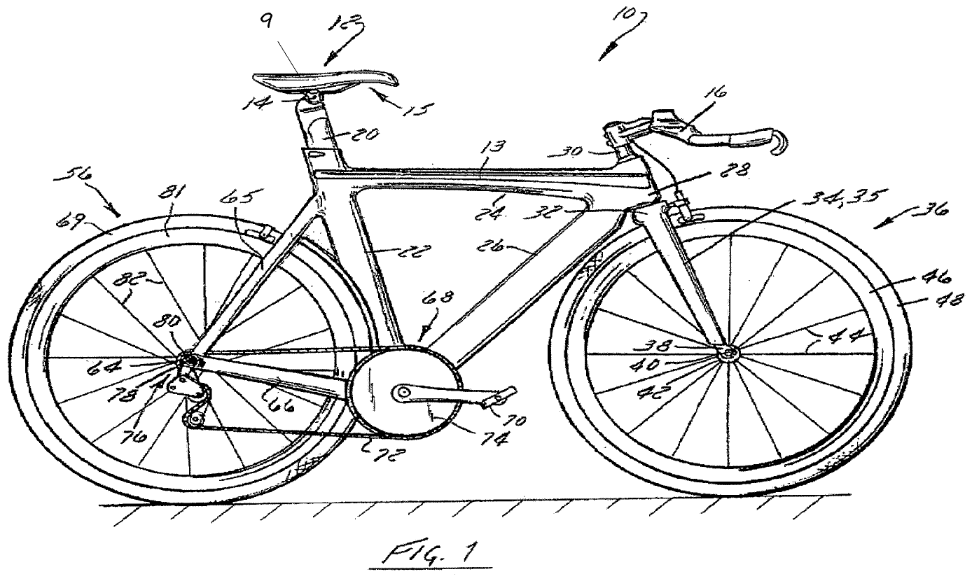

FIG. 1 depicts a bicycle 10 with a saddle 9 composed of truncated octahedron cells in accordance with an illustrative embodiment. The saddle 9 is described in more detail below. The bicycle 10 also includes a frame 13 to which a saddle assembly 12 and handlebars 16 are attached. The saddle 9 is part of the saddle assembly 12. A saddle clamp 14 is engaged with an underside 15 of saddle assembly 12 and cooperates with a saddle post 20 that slidably engages a saddle tube 22 of frame 13. As such, the position of the saddle 9 is adjustable relative to the frame 13 to accommodate different riders. A top tube 24 and a down tube 26 extend forwardly from saddle tube 22 to a head tube 28 of frame 13.

Handlebars 16 of the bicycle 10 are connected to a steerer tube 30 that passes through head tube 28 and engages a fork crown 32. A pair of fork blades 34, 35 extend from generally opposite ends of fork crown 32 and are constructed to support a front wheel assembly 36 at an end thereof or fork tip 38. The fork blades 34, 35 can be part of a suspension bicycle fork or a rigid bicycle fork. As also shown in FIG. 1, fork tips 38 engage generally opposite sides of an axle 40 that is constructed to engage a hub 42 of front wheel assembly 36. A number of spokes 44 extend from hub 42 to a rim 46 of front wheel assembly 36. A tire 48 is engaged with rim 46 such that rotation of tire 48, relative to forks 34, rotates rim 46 and hub 42.

A rear wheel assembly 56 is positioned generally concentrically about a rear axle 64. A seat stay 65 and a chain stay 66 offset rear axle 64 from a crankset 68. The crankset 68 includes pedals 70 that are operationally connected to a flexible drive such as a chain 72 via a chain ring or sprocket 74. Rotation of the chain 72 communicates a drive force to a rear section 76 of the bicycle 10 having a gear cluster 78 positioned thereat. The gear cluster 78 is generally concentrically orientated with respect to the rear axle 64 and includes a number of variable diameter gears. The gear cluster 78 is operationally connected to a hub 80 associated with a rear tire 69 of rear wheel assembly 56. A number of spokes 82 extend radially between the hub 80 and a rim 81 that supports tire 69 of rear wheel assembly 56. As is commonly understood, rider operation of the pedals 70 drives the chain 72 thereby driving the rear tire 69 which in turn propels the bicycle 10.

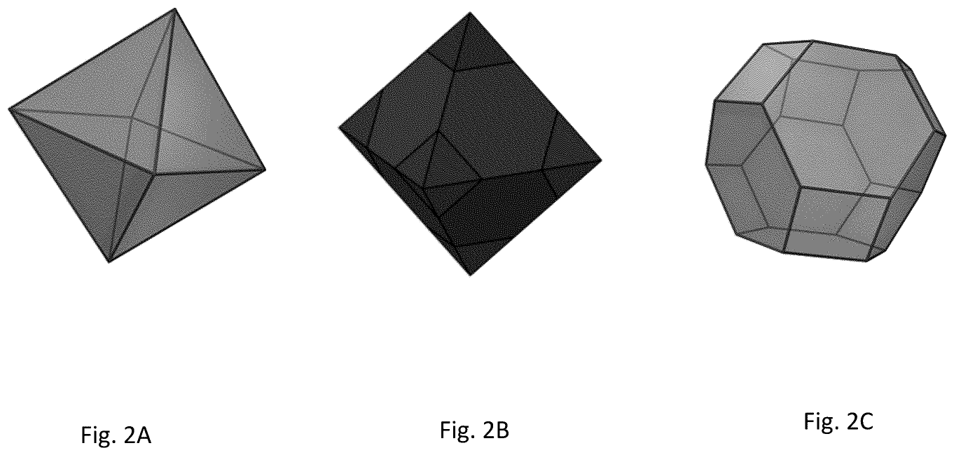

As discussed above, the proposed saddle is composed of a plurality of interconnected truncated octahedron cells (or unit cells). FIG. 2A depicts a full octahedron in accordance with an illustrative embodiment. As shown, the octahedron shape is essentially two four-sided pyramids of equal size that are connected at their bottoms. FIG. 2B depicts pyramids at the corners of the octahedron that are removed to form the truncated octahedron shape in accordance with an illustrative embodiment. As shown, there is a pyramid at each vertex of the octahedron for a total of six pyramids (one of which is not visible in the view of FIG. 2B). FIG. 2C depicts the truncated octahedron solid that results from removal of the pyramids shown in FIG. 2B in accordance with an illustrative embodiment. The truncated octahedron has 14 faces, 36 edges and 24 vertices.

In an illustrative embodiment, the proposed saddle can be formed by using a 3D printer to print a foam material to generate a plurality of interconnected truncated octahedrons. One of the major advantages of 3D printed foams is that the stiffness of the foam can be varied across the part. For a bicycle saddle, it has been found through ride testing and subjective feedback that a saddle is most comfortable when it is stiffer under the rider's sit bones (i.e., ischial tuberosity) and softer towards the front of the saddle. The use of 3D printing allows one to locally adjust the thickness of the struts which make up the truncated octahedron unit cells which in turn, adjusts the stiffness of the overall saddle cushion. This saddle cushion can be made using a variety of 3D printing methods, such as digital light processing (DLP), stereolithography (SLA), selective laser sintering (SLS), etc. Additionally, the saddle can be formed from a number of different materials, such as thermoplastic elastomers, thermoplastic polyurethanes, silicones, and elastic resins. Specific materials used can include Carbon 3D brand materials such as EPU 41, EPU 43, EPU 44, EPU 46, SIL 30, Formlabs brand materials such as TPU 90A Powder, BioMed Flex 80A, Flexible 80A resin, etc.

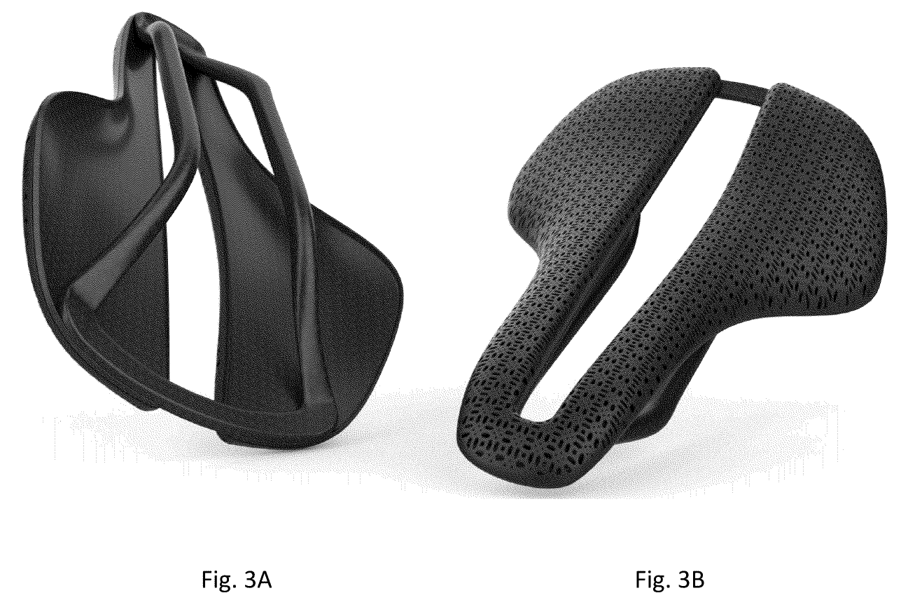

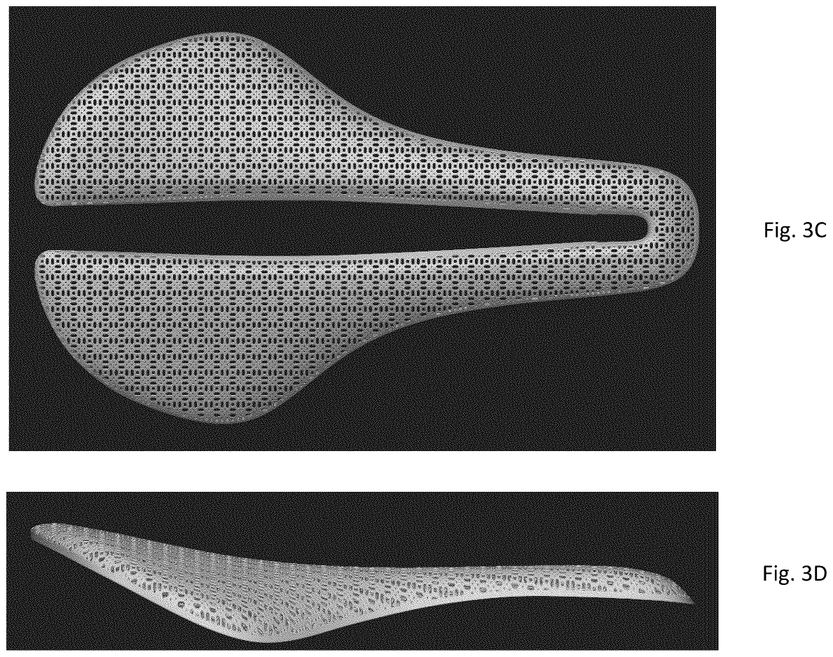

The 3D printed foam is made up of a series of repeating unit cells, and each unit cell is referred to herein as a ‘truncated octahedron.’ FIG. 3A is a bottom perspective view of a bicycle saddle that includes a saddle cushion mounted to a saddle base (or shell) in accordance with an illustrative embodiment. The saddle cushion can be mounted to the saddle base using an adhesive (e.g., a 2-part adhesive) or any other technique. As also shown, saddle rails are mounted to a bottom side of the saddle base. FIG. 3B is a top perspective view of the bicycle saddle of FIG. 3A in accordance with an illustrative embodiment. FIG. 3C is a top view of a 3D printed foam replacement saddle cushion in accordance with an illustrative embodiment. FIG. 3D is a side view of the 3D printed foam replacement saddle cushion in accordance with an illustrative embodiment.

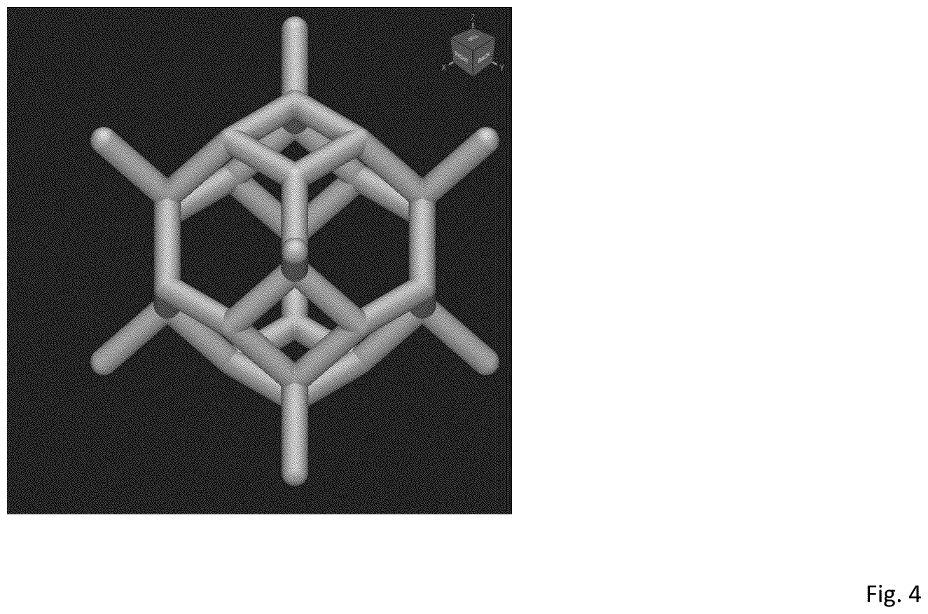

In an illustrative embodiment, a truncated octahedron lattice refers to a structure in which the struts of individual truncated octahedron cells are connected to one another to form a lattice that includes a plurality of interconnected truncated octahedron cells. Specifically, the struts are positioned at each edge of a truncated octahedron solid and the rest of the space is empty. FIG. 4 depicts a truncated octahedron with attached struts (i.e., from other truncated octahedrons) such that a truncated octahedron lattice can be formed in accordance with an illustrative embodiment.

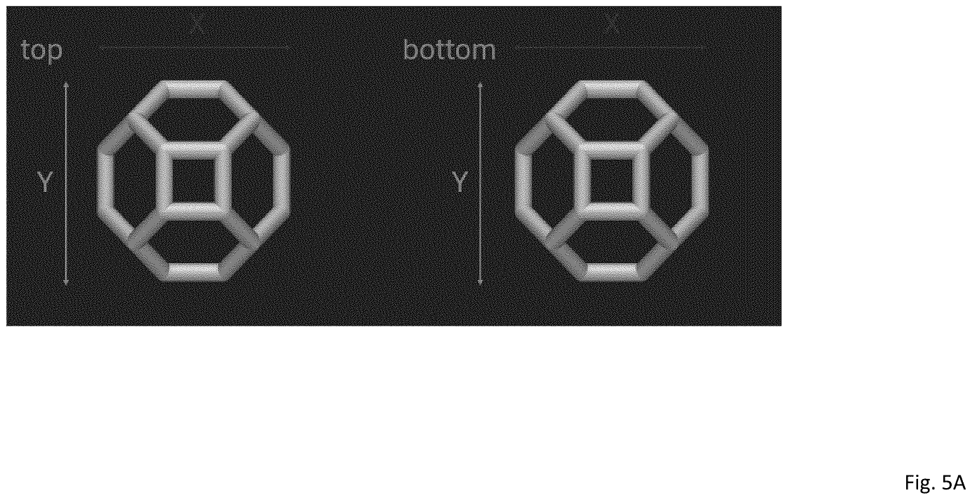

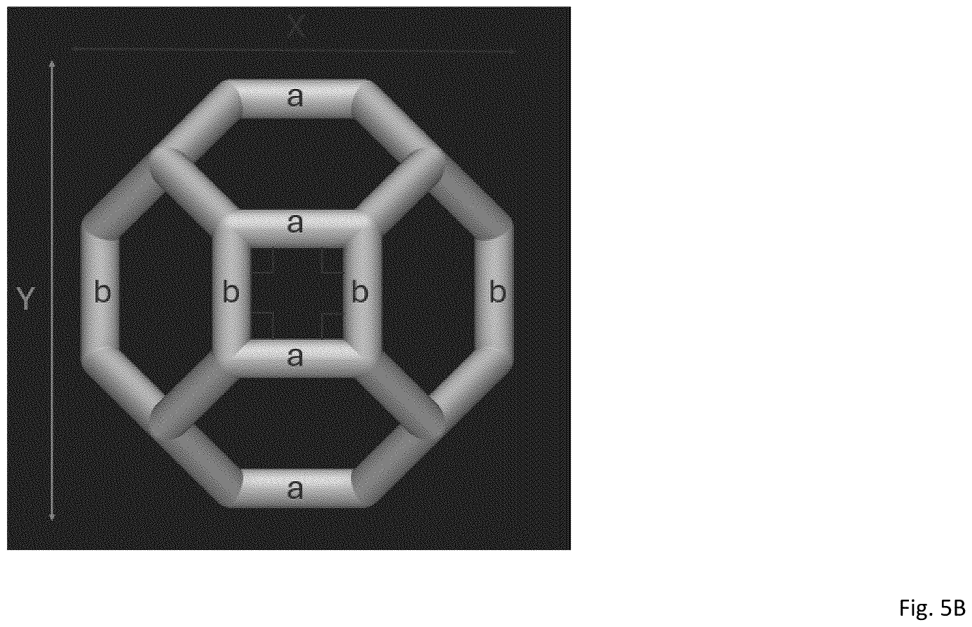

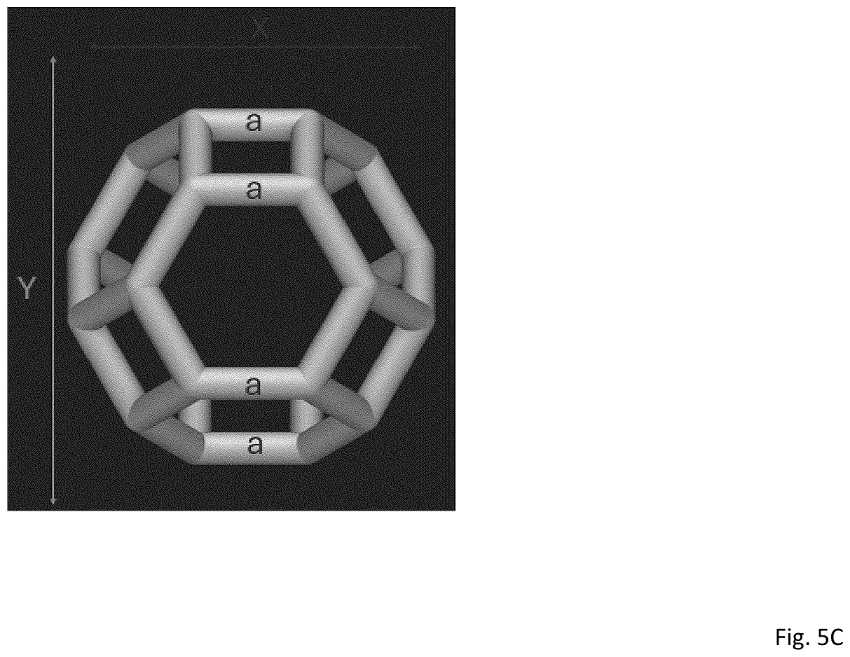

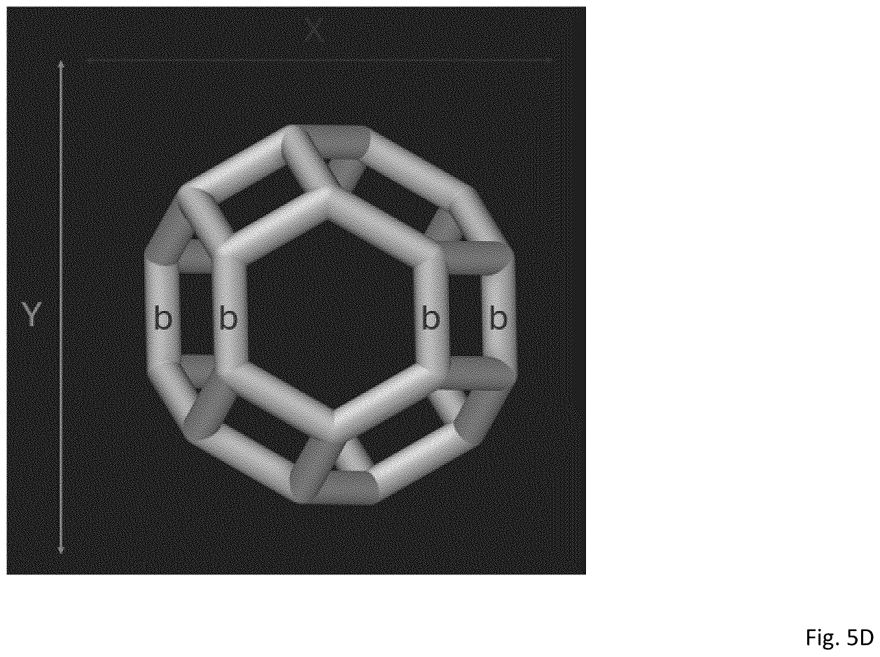

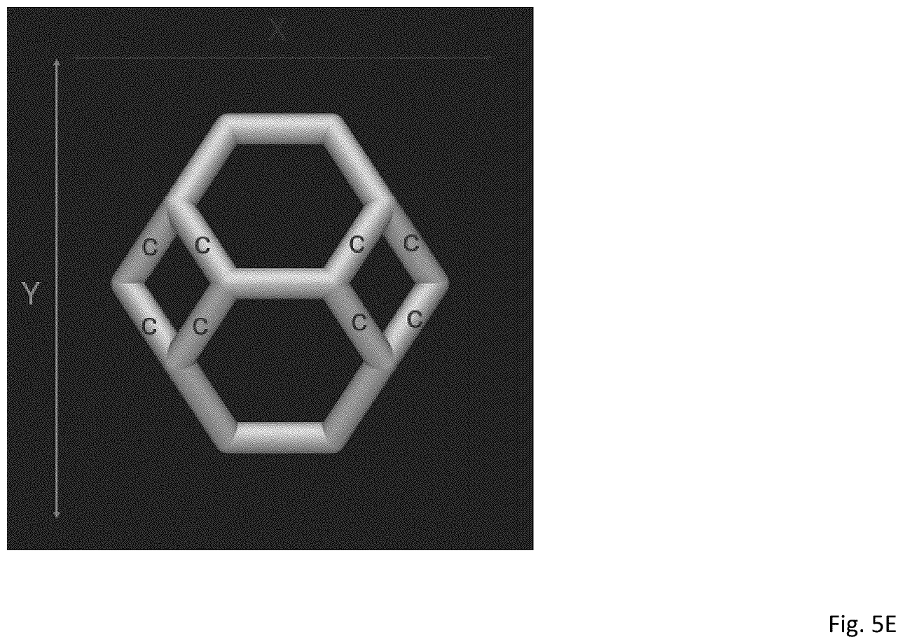

As discussed above, the truncated octahedron includes fourteen faces. The fourteen faces include two rectangular faces, a first set of four hexagonal faces (i.e., ‘a’ hexagonal faces), a second set of four hexagonal faces (i.e., ‘b’ hexagonal faces), and four diamond faces. FIG. 5A depicts the two rectangular faces of the truncated octahedron in accordance with an illustrative embodiment. Specifically, the left portion of FIG. 5A shows the top of the truncated octahedron, which includes a rectangular face at its center. The right portion of FIG. 5A shows the bottom of the truncated octahedron, which includes a rectangular face at its center. In an illustrative embodiment, the two rectangular faces shown in FIG. 5A are identical to one another and are always formed by 90° angles.

FIG. 5B is a bottom view of the truncated octahedron with labels showing like dimensions of the structure in accordance with an illustrative embodiment. In FIG. 5B and the following figures it is noted that all edges labelled ‘a’ are equal in length, all edges labeled ‘b’ are equal in length, and all edges labelled ‘c’ are equal in length. In an illustrative embodiment, the length ‘a’ is not equal to the length ‘b.’ As such, the face depicted at the bottom of the truncated octahedron is a rectangular face and not a square face. As also shown in FIG. 5B, the ‘a’ edges of the bottom rectangle (and similarly the top rectangle) are also the bottom and top edges of the ‘a’ hexagonal faces. Similarly, the ‘b’ edges of the top and bottom rectangles are also the bottom and top edges of the ‘b’hexagonal faces.

FIG. 5C is a view showing ‘a’ hexagonal faces in accordance with an illustrative embodiment. In the view of FIG. 5C, two of the ‘a’ hexagonal faces can be clearly seen. By rotating the truncated octahedron of FIG. 5C toward the viewer (i.e., about the x-axis), the other two ‘a’ hexagonal faces can be seen. In an illustrative embodiment, the four ‘a’ hexagonal faces are identical to one another. FIG. 5D is a view showing ‘b’ hexagonal faces in accordance with an illustrative embodiment. In the view of FIG. 5D, two of the ‘b’ hexagonal faces can be seen. By rotating the truncated octahedron of FIG. 5D about the y-axis, the other two ‘b’ hexagonal faces can also be seen. In an illustrative embodiment, the four ‘b’ hexagonal faces are identical to one another.

The remaining edges of the ‘a’ hexagonal faces and the ‘b’ hexagonal faces make up the edges of the four diamond faces. In an illustrative embodiment, the four diamond faces of the truncated octahedron are identical to one another and have edges of length ‘c.’ FIG. 5E is a view showing two of the four diamond faces of the truncated octahedron in accordance with an illustrative embodiment. The other two diamond faces can be seen by rotating the truncated octahedron about the y-axis. As shown, the diamond faces are the connecting faces between the ‘a’ hexagonal faces and the ‘b’ hexagonal faces.

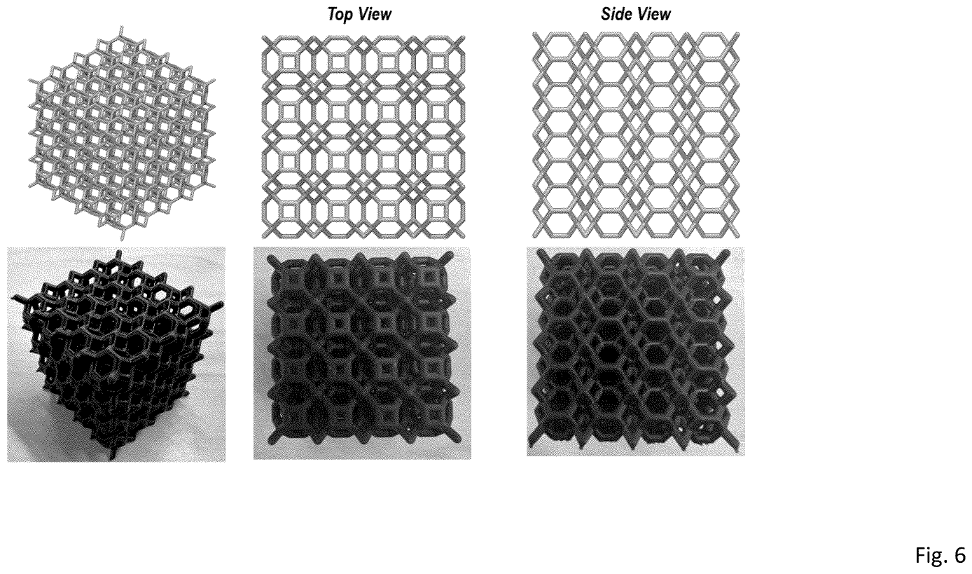

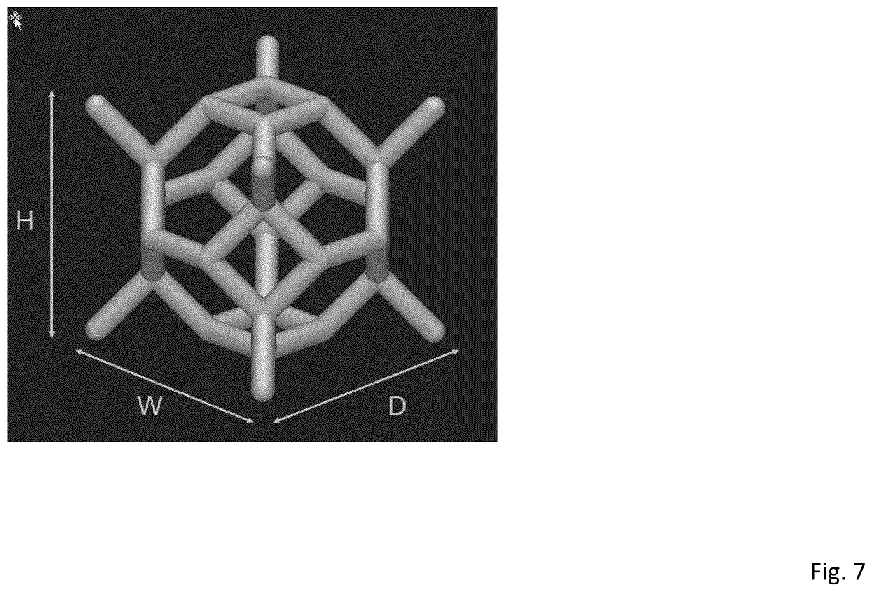

As discussed above, the truncated octahedrons are interconnected to one another via struts (i.e., of adjacent unit cells) to form a truncated octahedron lattice, as described with reference to FIG. 4. FIG. 6 depicts various views of a 4 cm×4 cm×4 cm truncated octahedron lattice structure containing truncated octahedron unit cells of size 1 cm×1 cm×1 cm in accordance with an illustrative embodiment. The top portion of FIG. 6 depicts simulated images of the 4 cm×4 cm×4 cm truncated octahedron lattice and the bottom portion of FIG. 6 depicts images of an actual printed 4 cm×4 cm×4 cm truncated octahedron lattice. The left views in FIG. 6 are perspective views of the 4×4 truncated octahedron lattice, the middle views in FIG. 6 are top views of the 4 cm×4 cm×4 cm truncated octahedron lattice, and the right views in FIG. 6 are side views of the 4 cm×4 cm×4 cm truncated octahedron lattice.

Each of the truncated octahedrons that form the lattice have an overall height (H), width (W), and depth (D). In an illustrative embodiment, the height, width, and depth can change independently from one another. Depending on the specific embodiment, the height, width, and/or depth can have dimensions that range from 0.1 millimeters (mm) to 30 mm. FIG. 7 depicts the height, width, and depth dimensions of a truncated octahedron cell with attached struts (i.e., from other truncated octahedrons)in accordance with an illustrative embodiment.

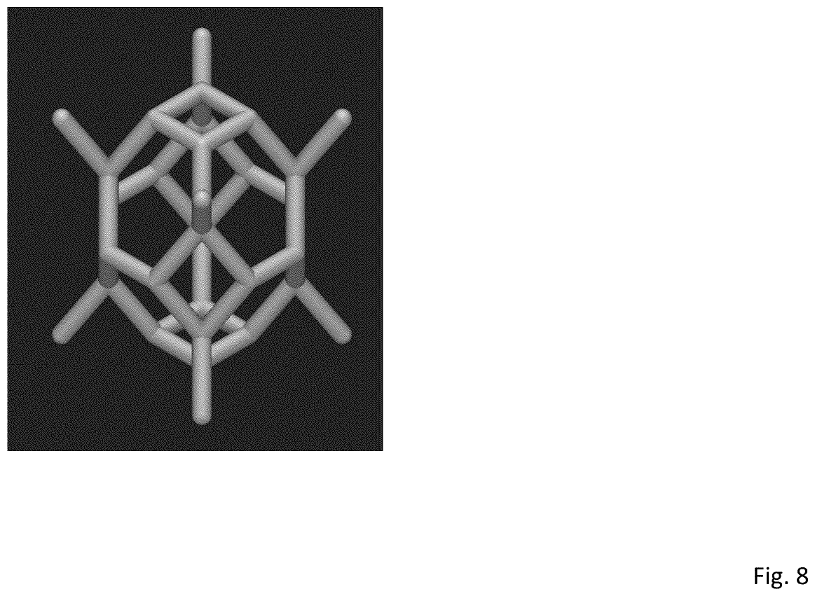

In an illustrative embodiment, the height of each truncated octahedron cell can be elongated relative to the width and depth of the cell. For example, in one embodiment the ratio of the height to the width (and the height to the depth) can be 4/3:1. Alternatively, a different ratio may be used, including a 1:1 ratio such that the height, width, and depth have the same dimension. In one embodiment, the ratios can vary up to 2.5:1, and other viable variations that were tested include ratios of 1.4:1, 1.5:1, and 5/3:1. In another alternative embodiment, the width and depth can have different dimensions. FIG. 8 depicts an elongated truncated octahedron cell in which the ratio of the height of the cell to the width of the cell is 4/3:1 in accordance with an illustrative embodiment.

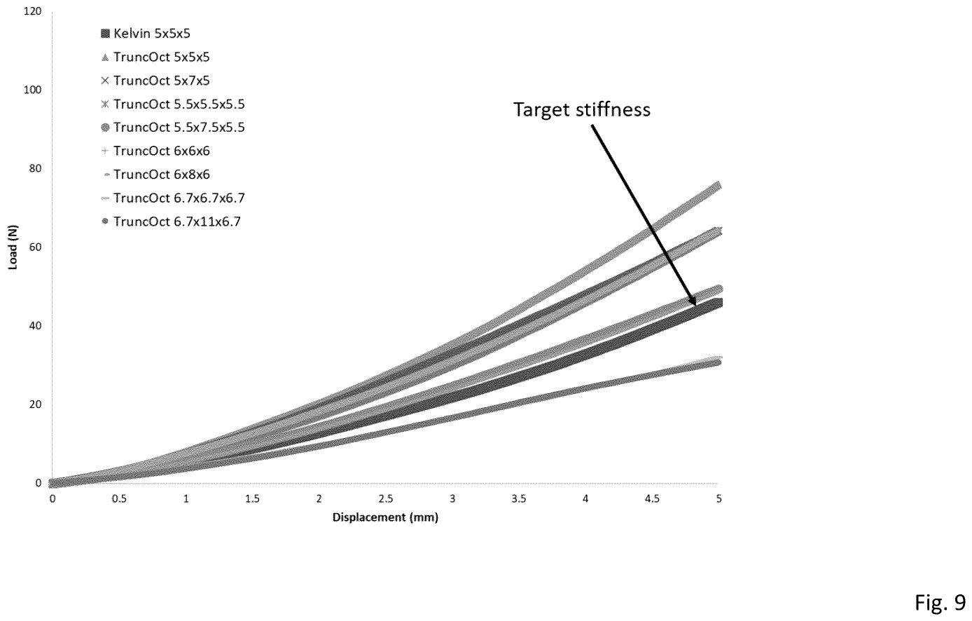

The reason for using a ratio of cell height to cell depth (or cell height to cell width) is to make the saddle cushion lighter by reducing the number of unit cells throughout the whole structure, while also providing the correct amount of support for the rider. The amount of support needed to support a given rider can be confirmed through compression stress vs. strain testing. FIG. 9 is a graph showing the results of testing load testing (Newtons) to determine the displacement (mm) of truncated octahedron lattices having various sizes in accordance with an illustrative embodiment. In the graph of FIG. 9, the legend includes dimensions for the width, height, and depth (i.e., W×H×D) of the various structures tested.

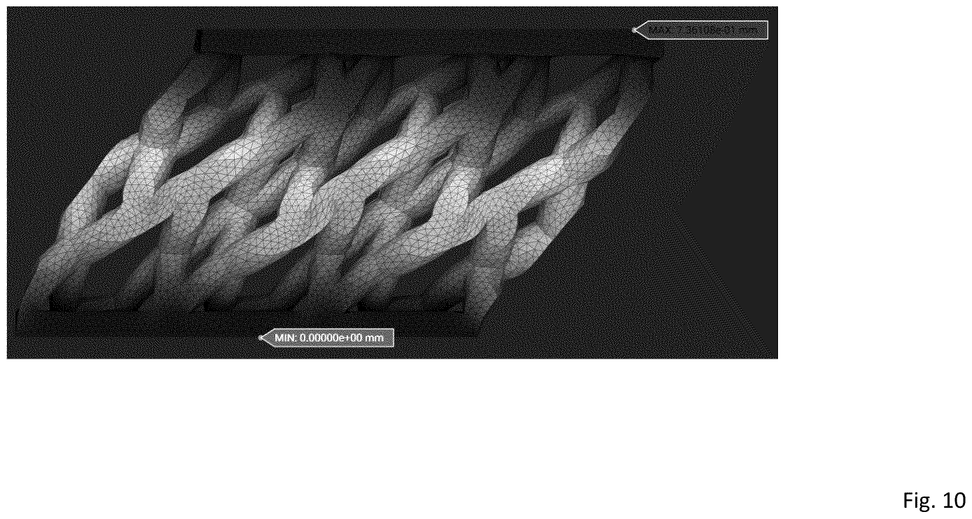

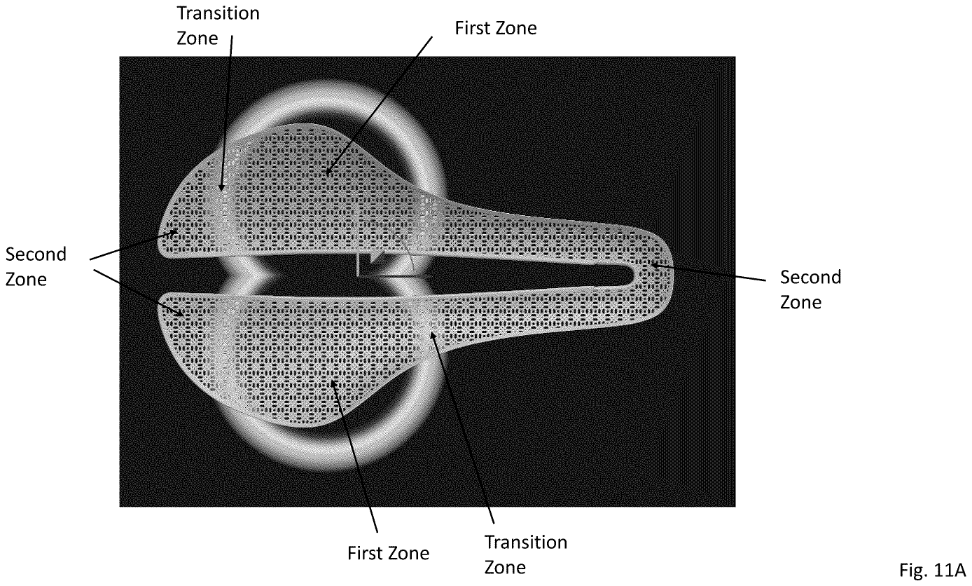

The 4/3:1 aspect ratio also enables the cells to shear parallel to the ground surface upon which the bicycle rests. This is beneficial because the top surface of the saddle can more easily move with the riders body, decreasing rubbing and saddle sores. FIG. 10 depicts a simulation of a 6×6×8 (4/3:1) truncated octahedron cell under shear force in accordance with an illustrative embodiment. To conduct the simulation, the bottom plate is fixed and the shear force is applied to the top plate from left to right. The significance of this shear movement is that the top surface of the lattice is able to move with the body as a rider is cycling. This is what drove the 4/3:1 height to depth/width ratio.

In another illustrative embodiment, different sizes of strut diameters can also be used for the struts that form the individual truncated octahedron cells (i.e., unit cell struts). In one embodiment, the struts can have a diameter that ranges from 0.01 mm to 7 mm. Strut diameters can also change throughout a single saddle with a transition zone (of any size) between varying strut diameters. In one embodiment, the strut diameter changes from 1.1 mm (in a first zone of the saddle cushion that receives the sits bones of the rider) to 1.0 mm (in a second zone of the saddle cushion that does not receive the sits bones of the rider). Alternatively, different diameters may be used (e.g. 0.9 mm, 1.2 mm, 1.4 mm, etc.) A transition zone between can be used between the first zone and the second zone.

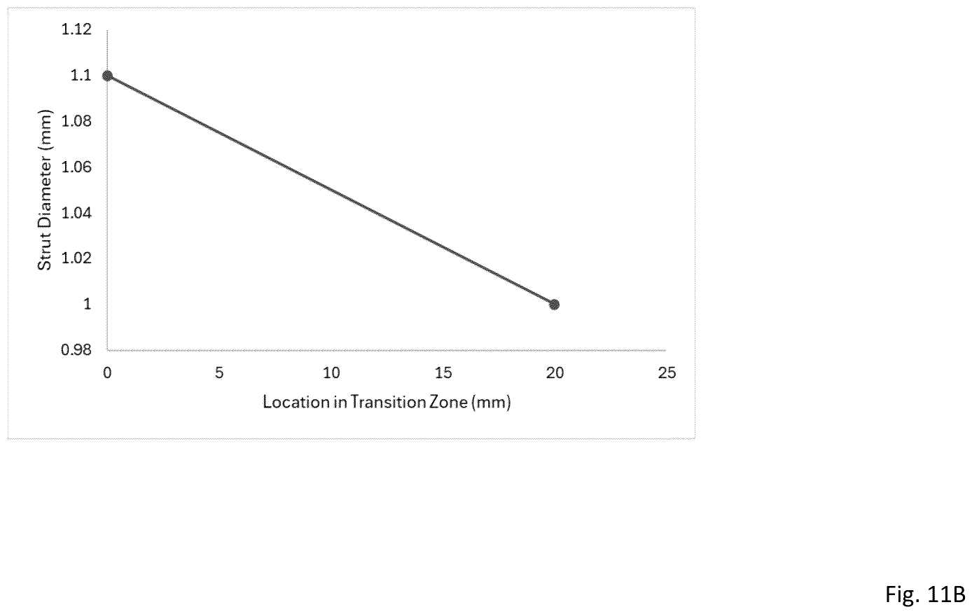

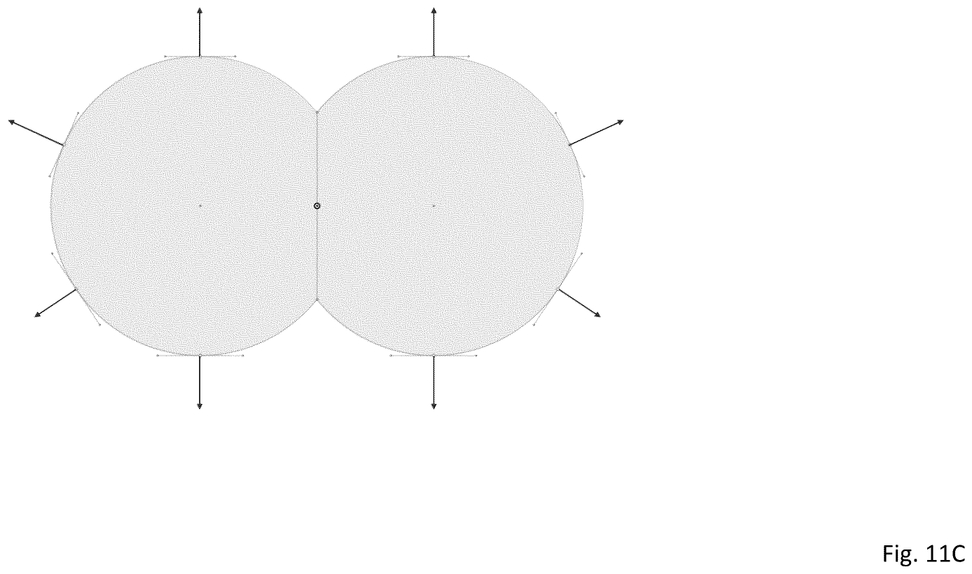

FIG. 11A depicts strut diameter zones of a saddle cushion in accordance with an illustrative embodiment. As shown, FIG. 11A includes a shape formed by two overlapping 40 mm circles (overlap shape), and upon which the saddle cushion is overlaid. The portion of the saddle cushion that is within an inner boundary of the overlap shape can be referred to as the first zone of the saddle cushion, the portion of the saddle cushion that is outside of the outer boundary of the overlap shape can be referred to as the second zone of the saddle cushion, and the portion of the saddle cushion that is between the inner and outer boundaries of the overlap shape can be referred to as the transition zone of the saddle cushion. As discussed above, in one embodiment struts of the truncated octahedron lattice that are in the first zone can have a first diameter (e.g., 1.1 mm), struts of the truncated octahedron lattice that are in the second zone can have a second diameter (e.g., 1.0 mm) that is smaller than the first diameter, and struts of the truncated octahedron lattice that are in the transition zone can have one or more diameters that are between the first diameter and the second diameter.

In an illustrative embodiment, the strut diameter ramps linearly between the first zone and the second zone. As an example, FIG. 11B is a chart that shows strut diameter in a 20 mm transition zone positioned between a first zone with 1.1 mm struts and a second zone with 1 mm struts in accordance with an illustrative embodiment. As shown, the location in the transition zone corresponding to 0 mm is on the outer edge of the first zone and the location in the transition zone corresponding to 20 mm is on the outer edge (the start) of the second zone. In another illustrative embodiment, the direction that the struts ramp is perpendicular to the first zone tangent edges. FIG. 11C depicts a portion of the overlap shape that defines the first saddle zone and shows that the direction the struts ramp is perpendicular to tangent edges of the first zone in accordance with an illustrative embodiment.

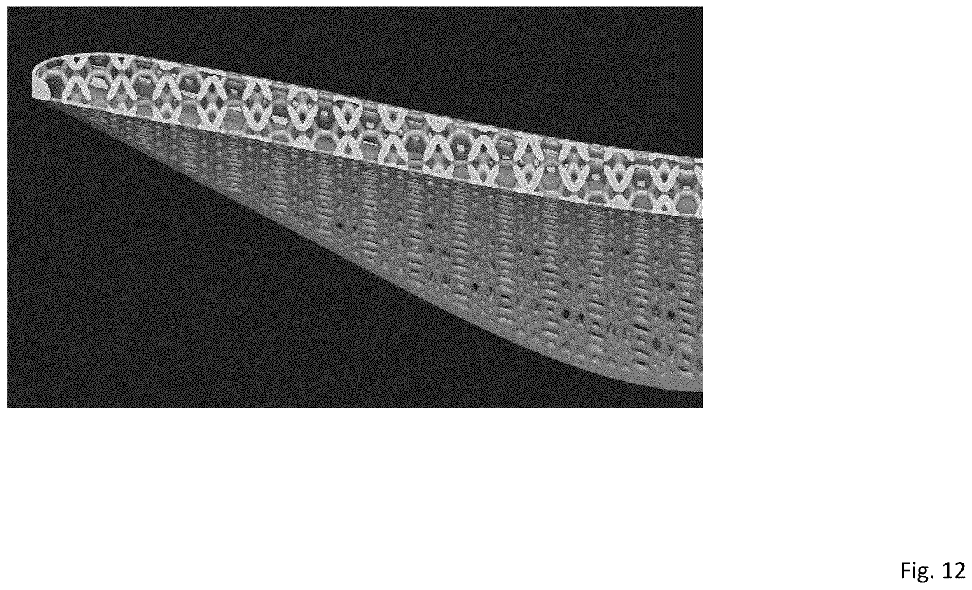

In an illustrative embodiment, the lattice network of truncated octahedron cells can take on any orientation in the XYZ plane. In one embodiment, the cells are oriented with the cell height perpendicular to the ground surface (i.e., upon which the bicycle tires rest). FIG. 12 depicts a portion of a saddle cushion in which the truncated octahedron cells of the lattice are oriented such that cell height is perpendicular to the ground surface upon which the bicycle rests in accordance with an illustrative embodiment.

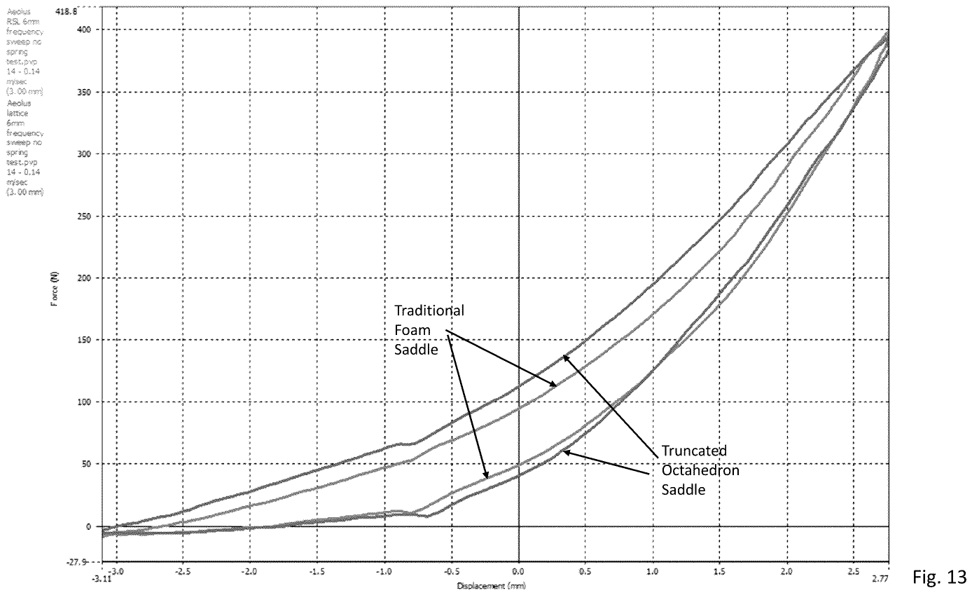

FIG. 13 is a graph that shows the results of dynamometer testing done in a suspension lab in accordance with an illustrative embodiment. The results indicate that a saddle with a 3D printed truncated octahedron lattice has better dampening properties than a traditional foam saddle. As shown, the results depict a pair of curves corresponding to the truncated octahedron saddle and another pair of curves corresponding to a traditional foam saddle. The area in between the pairs of curves indicates the amount of hysteresis, and the larger area between the curves corresponding to the truncated octahedron saddle therefore indicates more hysteresis as compared to the traditional foam saddle. This increased damping translates to increased rider comfort.

The truncated octahedron cell type allows one to make a lightweight saddle foam due to the high strength-to-weight properties of these cells. To validate this, a study was conducted in which various cell types were evaluated for their strength and weight. Lattice cubes using various cell shapes were printed, with each cube being 4 centimeters (cm)×4 cm×4 cm. Each unit cell was 1 cm×1 cm×1 cm. The cell shapes/types were simple cubic, base centered cubic, face centered cubic, fluorite, octet, truncated cube, truncated octahedron, kelvin, isotruss, reentrant, weaire-phelan, triangular honeycomb, hexagonal honeycomb, and lidinoid. The struts for every lattice structure were 1 mm in diameter, although other diameters can be used in alternative embodiments, such as 0.8 mm, 0.9 mm. 1.2 mm, etc. These cells were put through compression testing on a universal tester (100 pound load cell, 0.3 mm/sec). Specifically, the force required to compress each cube to 15 mm was recorded. Also, the weight of each cube was recorded. The force was then divided by the weight to give a strength-to-weight value.

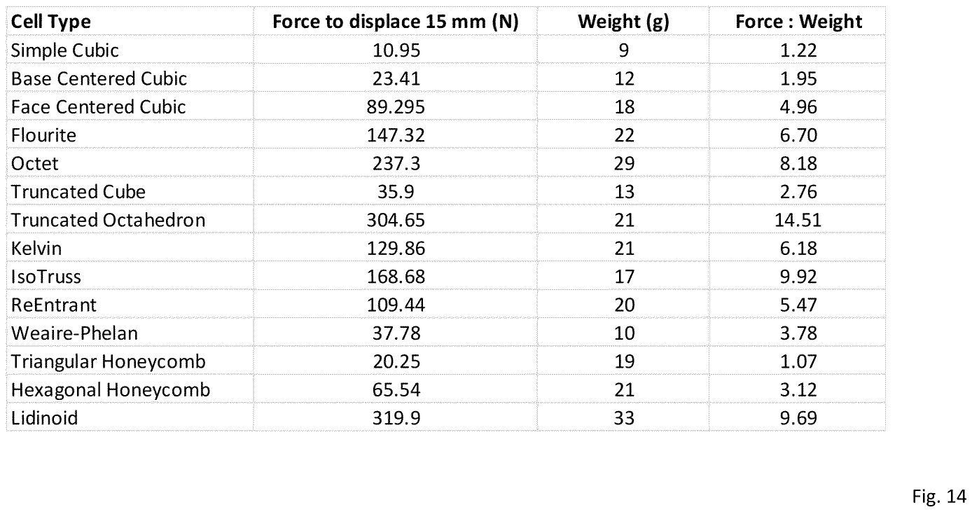

FIG. 14 is a table that depicts results of the load testing of lattice cubes having various cell shapes/types in accordance with an illustrative embodiment. As shown, the truncated octahedron was a clear winner and was therefore identified as the optimal cell type to use for the saddle cushion. The truncated octahedron cell type allows construction of a saddle cushion with greatly reduced weight, while still providing excellent support. In one implementation, a saddle made using truncated octahedron cells weights 160 grams (g), as compared to traditional saddles that weight 195 g or more.

Thus, described herein is a saddle cushion in which the cushion structure provides the ability to finely tune the stiffness of foam throughout one, continuous product. The proposed saddle cushion is also lighter than traditional cushions due to the high strength-to-weight ratio of truncated octahedron cells that form the saddle cushion.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more”.

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A bicycle saddle, comprising:
a saddle base; and
a saddle cushion that mounts to the saddle base, wherein the saddle cushion comprises:
a plurality of unit cells, wherein each unit cell in the plurality of unit cells comprises a truncated octahedron; and
wherein each unit cell in the plurality of unit cells is formed from a plurality of unit cell struts that interconnect to form a lattice of unit cells.

2. The bicycle saddle of claim 1, wherein each unit cell in the plurality of unit cells has a height, a width, and a depth, and wherein the height is greater than the width.

3. The bicycle saddle of claim 2, wherein a ratio of the height to the width of each unit cell is 4/3:1.

4. The bicycle saddle of claim 1, wherein each unit cell in the plurality of unit cells has a height, a width, and a depth, and wherein the height is greater than the depth.

5. The bicycle saddle of claim 4, wherein a ratio of the height to the depth of each unit cell is 4/3:1.

6. The bicycle saddle of claim 4, wherein the plurality of unit cells are oriented such that the height of each unit cell is perpendicular to a ground surface.

7. The bicycle saddle of claim 1, wherein the plurality of unit cell struts vary in diameter across the saddle cushion.

8. The bicycle saddle of claim 1, wherein the saddle cushion includes a first zone that is positioned to receive sits bones of a user and a second zone that is positioned to not receive the sits bones of the user, wherein unit cell struts used in the first zone have a first diameter and unit cell struts used in the second zone have a second diameter that differs from the first diameter.

9. The bicycle saddle of claim 8, wherein the first diameter is greater than the second diameter.

10. The bicycle saddle of claim 8, wherein the first diameter comprises 1.1 millimeters and the second diameter comprises 1 millimeter.

11. The bicycle saddle of claim 8, wherein the saddle cushion also includes a transition zone that is in between the first zone and the second zone, and wherein at least a portion of the unit cell struts used in the transition zone have a third diameter that differs from the first diameter and the second diameter.

12. The bicycle saddle of claim 11, wherein the third diameter is smaller than the first diameter and larger than the second diameter.

13. The bicycle saddle of claim 1, wherein the truncated octahedron that forms each cell includes a first set of hexagonal faces having first dimensions and a second set of hexagonal faces having second dimensions, and wherein the first dimensions differ from the second dimensions.

14. The bicycle saddle of claim 1, wherein a ratio of a height to a depth of each unit cell is up to 2.5:1.

15. A saddle cushion for a bicycle saddle comprising:
a lattice that comprises:
a plurality of unit cells, wherein each unit cell in the plurality of unit cells comprises a truncated octahedron; and
wherein each unit cell in the plurality of unit cells is formed from a plurality of unit cell struts that interconnect to form a lattice of unit cells.

16. The saddle cushion of claim 15, wherein each unit cell in the plurality of unit cells has a height, a width, and a depth, and wherein the height is greater than the width and the depth.

17. The saddle cushion of claim 16, wherein a ratio of the height to the depth of each unit cell is 4/3:1

18. The saddle cushion of claim 16, wherein the plurality of unit cells are oriented such that the height of each unit cell is perpendicular to a ground surface.

19. The saddle cushion of claim 15, wherein the saddle cushion includes a first zone that is positioned to receive sits bones of a user and a second zone that is positioned to not receive the sits bones of the user, wherein unit cell struts used in the first zone have a first diameter and unit cell struts used in the second zone have a second diameter that is smaller than the first diameter.

20. The saddle cushion of claim 15, wherein the truncated octahedron that forms each cell includes a first set of hexagonal faces having first dimensions and a second set of hexagonal faces having second dimensions, and wherein the first dimensions differ from the second dimensions.
